(19) United States
(12) Patent Application Publication
(10) Pub. No.: US 2022/0244557 A1
(43) Pub. Date: Aug. 4, 2022

(54) LIGHT PATTERN GENERATION DEVICE

(71) Applicant: MITSUBISHI ELECTRIC CORPORATION, Tokyo (JP)

(72) Inventors: Wataru YOSHIKI, Tokyo (JP); Yukari MIYAGI, Tokyo (JP); Masaharu IMAKI, Tokyo (JP); Takayuki NAKANO, Tokyo (JP)

(73) Assignee: MITSUBISHI ELECTRIC CORPORATION, Tokyo (JP)

(21) Appl. No.: 17/725,907

(22) Filed: Apr. 21, 2022

Related U.S. Application Data
(63) Continuation of application No. PCT/JP2019/046471, filed on Nov. 28, 2019.

(51) Int. Cl. G02B 27/42; G02B 26/10

(52) U.S. Cl. CPC G02B 27/4227; G02B 5/045; G02B 26/10

(57) ABSTRACT

A light pattern generation device is provided with a laser light source to emit laser light, a light scanner to deflect the laser light emitted from the laser light source, and a diffractive optical element unit including a plurality of diffractive optical element components each of which modulates at least one of phase distribution or intensity distribution of the laser light deflected by the light scanner so that the laser light that passes therethrough forms a predetermined light pattern on an image plane. The light scanner can change a deflection direction in which the laser light emitted from the laser light source is deflected so that the laser light emitted from the laser light source is deflected toward a predetermined diffractive optical element component out of the plurality of diffractive optical element components.

### CROSS REFERENCE TO RELATED APPLICATIONS

This application is a Continuation of PCT International Application No. PCT/JP2019/046471, filed on Nov. 28, 2019, which is hereby expressly incorporated by reference into the present application.

### TECHNICAL FIELD

The present invention relates to a light pattern generation device.

### BACKGROUND ART

In some light pattern generation devices, a laser light source and a diffractive optical element (DOE) are utilized. The diffractive optical element modulates at least one of intensity distribution or phase distribution of laser light emitted from the laser light source so that the laser light that passes therethrough forms a predetermined light pattern on an image plane.

Patent Literature 1 discloses a light pattern generation device that displays animation on an image plane by switching a light pattern displayed on the image plane. More specifically, the light pattern generation device is provided with a disk-shaped diffractive optical element including a plurality of optical element components each of which modulates phase distribution of the laser light, and a rotation mechanism that rotates the diffractive optical element. The plurality of optical element components corresponds to portions of the diffractive optical element divided by a plurality of lines radially extending from the center to an outer periphery of a disk surface. The rotation mechanism rotates the diffractive optical element in one direction about an axis passing through the center of the disk surface and perpendicular to the disk surface as a rotation axis, and switches the light pattern displayed on the image plane by continuously switching the optical element component through which the laser light passes among a plurality of optical element components.

### CITATION LIST

### Patent Literatures

Patent Literature 1: Japanese Patent No. 6508425

### SUMMARY OF INVENTION

### Technical Problem

In the technology disclosed in Patent Literature 1 described above, order of the light patterns formed on the image plane is uniquely determined by arrangement of each of the plurality of optical element components in the diffractive optical element and a rotation direction by the rotation mechanism, and thus there is a problem that flexibility of the order of the displayed light patterns is limited.

The present invention is devised to solve the above-described problem, and an object thereof is to provide a technology for improving flexibility of order of displayed light patterns.

### Solution to Problem

A light pattern generation device according to the present invention includes a laser light source to emit laser light; a light scanner to deflect the laser light emitted from the laser light source; a diffractive optical element unit including a plurality of diffractive optical element components each of which modulates at least one of phase distribution or intensity distribution of the laser light deflected by the light scanner so that the laser light that passes through each of the diffractive optical element components forms a predetermined light pattern on an image plane; and a light scanner driver to control a deflection direction of the light scanner in which the laser light emitted from the laser light source is deflected and a timing at which the deflection direction of the light scanner is changed so that the light scanner deflects the laser light emitted from the laser light source toward a predetermined diffractive optical element component out of the plurality of diffractive optical element components at a predetermined timing. The light scanner is capable of changing the deflection direction so that the laser light emitted from the laser light source is deflected toward a predetermined diffractive optical element component out of the plurality of diffractive optical element components. The light scanner driver controls the deflection direction of the light scanner and the timing at which the deflection direction of the light scanner is changed in such a manner that the light pattern displayed on the image plane is switched by continuously switching the diffractive optical element component through which the laser light deflected by the light scanner passes among the plurality of diffractive optical element components in a predetermined order so that animation is displayed in a same position on the image plane. A pitch of each of the plurality of diffractive optical element components, each of which includes a plurality of periodically divided minute portions, the pitch being a width of each of the minute portions, is set so that the laser light that passes through each of the diffractive optical element components forms a predetermined light pattern in the same position on the image plane.

A light pattern generation device according to the present invention includes a laser light source to emit laser light; a light scanner to deflect the laser light emitted from the laser light source; a diffractive optical element unit including a plurality of diffractive optical element components each of which modulates at least one of phase distribution or intensity distribution of the laser light deflected by the light scanner so that the laser light that passes through each of the diffractive optical element components forms a predetermined light pattern on an image plane; and a light scanner driver to control a deflection direction of the light scanner in which the laser light emitted from the laser light source is deflected and a timing at which the deflection direction of the light scanner is changed so that the light scanner deflects the laser light emitted from the laser light source toward a predetermined diffractive optical element component out of the plurality of diffractive optical element components at a predetermined timing. The light scanner is capable of changing the deflection direction so that the laser light emitted from the laser light source is deflected toward a predetermined diffractive optical element component out of the plurality of diffractive optical element components. The light scanner driver controls the deflection direction of the light scanner and the timing at which the deflection direction of the light scanner is changed in such a manner that the light pattern displayed on the image plane is switched by continuously switching the diffractive optical element component through which the laser light deflected by the light scanner passes among the plurality of diffractive optical element components in a predetermined order so that animation is displayed in a same position on the image plane. An incident angle correction optical system to convert the laser light deflected by the light scanner into parallel light whose incident angle with respect to the predetermined diffractive optical element component is constant independently of the deflection direction of the light scanner is mounted between the light scanner and the diffractive optical element unit. A re-condensing optical system to condense the parallel light emitted from the predetermined diffractive optical element component in the same position on the image plane independently of the diffractive optical element component through which the laser light passes is mounted between the diffractive optical element unit and the image plane.

### Advantageous Effects of Invention

According to the present invention, flexibility of order of displayed light patterns can be improved.

### BRIEF DESCRIPTION OF DRAWINGS

FIG. 1 is a diagram illustrating a configuration of a light pattern generation device according to a first embodiment.

FIG. 2 is a diagram illustrating a configuration of a diffractive optical element unit of the light pattern generation device according to the first embodiment.

FIG. 3 is a diagram illustrating light patterns formed on an image plane by laser light that passes through a plurality of diffractive optical element components in the diffractive optical element unit illustrated in FIG. 2.

FIG. 4 is a diagram illustrating a configuration of a light pattern generation device according to a second embodiment.

FIG. 5 is a diagram illustrating a configuration of a diffractive optical element unit of the light pattern generation device according to the second embodiment.

FIG. 6 is a diagram illustrating light patterns formed on an image plane by laser light that passes through a plurality of diffractive optical element components in the diffractive optical element unit illustrated in FIG. 5.

FIG. 7 is a diagram illustrating an example in Which a two-dimensional scan element is used as a light scanner of the light pattern generation device according to the second embodiment.

FIG. 8 is a diagram illustrating an example in which a one-dimensional scan element and an addressing optical system are used as a light scanner of the light pattern generation device according to the second embodiment.

FIG. 9 is a diagram illustrating a configuration of a light pattern generation device according to a third embodiment.

FIG. 10 is a diagram illustrating a configuration of a first specific example of an incident angle correction optical system according to the third embodiment.

FIG. 11 is a diagram illustrating a configuration of a second specific example of the incident angle correction optical system according to the third embodiment.

FIG. 12 is a diagram illustrating a configuration of a light pattern generation device according to a fourth embodiment.

FIG. 13 is a diagram illustrating a configuration of a light pattern generation device according to a fifth embodiment.

### DESCRIPTION OF EMBODIMENTS

Some modes for carrying out the present invention are hereinafter described with reference to the attached drawings in order to describe the present invention in further detail.

### First Embodiment

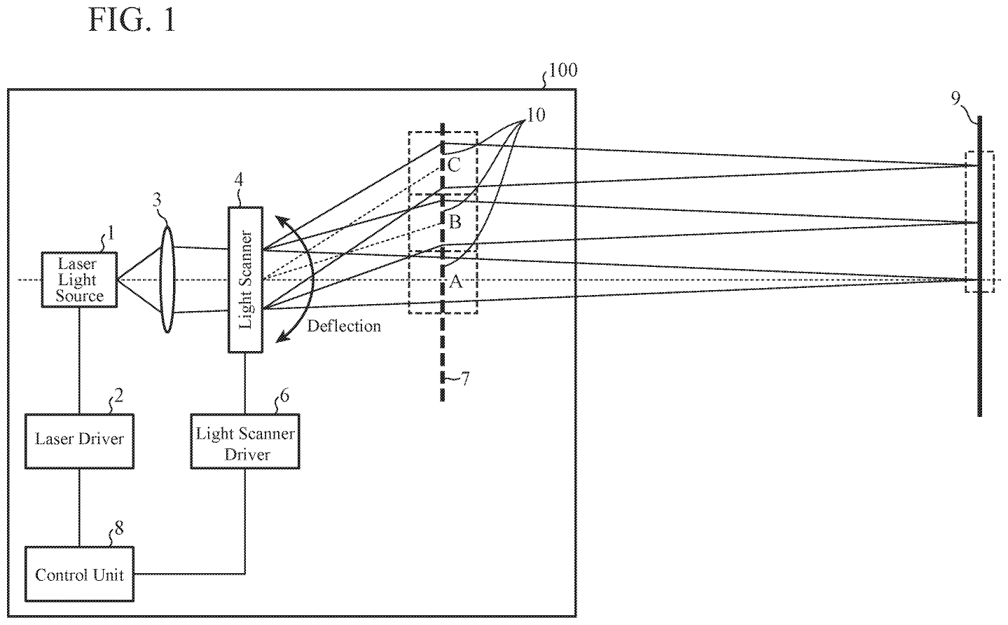

FIG. 1 is a diagram illustrating a configuration of a light pattern generation device 100 according to a first embodiment. As illustrated in FIG. 1, the light pattern generation device 100 is provided with a laser light source 1, a laser driver 2, a condensing optical system 3, a light scanner 4, a light scanner driver 6, a diffractive optical element unit 7, and a control unit 8. Note that, an image plane 9 is mounted on an optical path of laser light emitted from the diffractive optical element unit 7 described later.

The laser light source 1 emits laser light. The laser driver 2 is connected to the laser light source 1. The laser driver 2 controls a waveform or an intensity of the laser light emitted from the laser light source 1.

The condensing optical system 3 is mounted on an optical path of the laser light emitted from the laser light source 1. The condensing optical system 3 converts the laser light emitted from the laser light source 1 into light to be condensed on the image plane 9. The condensing optical system 3 is, for example, an optical element such as a lens that refracts the laser light transmitted therethrough or an optical element such as a mirror that reflects the laser light.

In the first embodiment, a configuration in which the condensing optical system 3 is used is described, but a collimating optical system may be used in place of the condensing optical system 3. In this case, the collimating optical system converts the laser light emitted from the laser light source 1 into parallel light. As a result, even in a case where the light pattern generation device 100 and the image plane 9 are sufficiently separated from each other, the light pattern can be formed on the image plane 9. Alternatively, in a case where the laser light source 1 has a condensing function, the light pattern generation device 100 need not be provided with the condensing optical system 3. As a result, the number of parts of the optical system can be reduced, so that cost reduction and downsizing can be achieved.

The light scanner 4 is mounted on the optical path of the laser light emitted from the laser light source 1. The light scanner 4 deflects the laser light emitted from the laser light source. In the first embodiment, the light scanner 4 is mounted on an optical path of the laser light emitted from the condensing optical system 3. The light scanner 4 deflects the laser light emitted from the condensing optical system 3.

The light scanner driver 6 is connected to the light scanner 4. The light scanner driver 6 controls a deflection direction in which the light scanner 4 deflects the laser light and a timing at which the deflection direction of the light scanner 4 is changed. The light scanner driver 6 is, for example, micro electro-mechanical systems (MEMS), an acoustic optical element, or a galvano scanner.

The diffractive optical element unit 7 is mounted on an optical path of the laser light emitted from the light scanner 4. The diffractive optical element unit 7 includes a plurality of diffractive optical element components 10 each of which modulates at least one of phase distribution or intensity distribution of the laser light deflected by the light scanner 4 so that the laser light that passes therethrough forms a predetermined light pattern on the image plane 9.

A material of the diffractive optical element unit 7 is, for example, glass or resin. In the first embodiment, the diffractive optical element unit 7 is a single diffractive optical element, the single diffractive optical element is divided into a plurality of portions, and each portion out of the plurality of portions corresponds to the diffractive optical element component 10. However, the diffractive optical element unit 7 is not limited to this configuration. For example, the diffractive optical element unit 7 may be obtained by two-dimensionally arranging a plurality of diffractive optical elements as the plurality of diffractive optical element components 10.

The light scanner 4 described above can change the deflection direction in which the laser light emitted from the laser light source 1 is deflected so as to deflect the laser light emitted from the laser light source 1 toward any predetermined diffractive optical element component out of the plurality of diffractive optical element components 10. In other words, the light scanner 4 can change the deflection direction in which the laser light emitted from the laser light source 1 is deflected so that the laser light emitted from the laser light source 1 is incident on a predetermined diffractive optical element component out of the plurality of diffractive optical element components.

In the first embodiment, the light scanner 4 can change the deflection direction in which the laser light emitted from the condensing optical system 3 is deflected so as to deflect the laser light emitted from the condensing optical system 3 toward a predetermined diffractive optical element component out of the plurality of diffractive optical element components 10.

The light scanner driver 6 described above controls the deflection direction of the light scanner 4 and the timing at which the deflection direction of the light scanner 4 is changed so that the light scanner 4 deflects the laser light emitted from the laser light source 1 toward a predetermined diffractive optical element component out of the plurality of diffractive optical element components 10 at any predetermined timing. In the first embodiment, the light scanner driver 6 controls the deflection direction of the light scanner 4 and the timing at which the deflection direction of the light scanner 4 is changed so that the light scanner 4 deflects the laser light emitted from the condensing optical system 3 toward a predetermined diffractive optical element component out of the plurality of diffractive optical element components 10 at a predetermined timing.

More specifically, the light scanner driver 6 controls the deflection direction of the light scanner 4 and the timing at which the deflection direction of the light scanner 4 is changed so that animation is displayed on the image plane 9 by continuously changing the diffractive optical element component 10 through which the laser light deflected by the light scanner 4 passes among the plurality of diffractive optical element components 10.

The control unit 8 is connected to each of the laser driver 2 and the light scanner driver 6, controls the laser light source 1 via the laser driver 2, and controls the light scanner 4 via the light scanner driver 6.

Hereinafter, the configuration of the diffractive optical element unit 7 is described in detail. In each of the plurality of diffractive optical element components 10 in the diffractive optical element unit 7, at least one of an optical path length pattern or a transmittance pattern is set so that the laser light that passes therethrough forms a predetermined light pattern on the image plane 9.

For example, in a case where the optical path length pattern of each of the plurality of diffractive optical element components 10 is set so that the laser light that passes therethrough forms a predetermined light pattern on the image plane 9, each of the plurality of diffractive optical element components 10 can modulate the phase distribution of the laser light deflected by the light scanner 4 so that the laser light that passes therethrough forms a predetermined light pattern on the image plane 9 by this means.

For example, in a case where the transmission pattern of each of the plurality of diffractive optical element components 10 is set so that the laser light that passes therethrough forms a predetermined light pattern on the image plane 9, each of the plurality of diffractive optical element components 10 can modulate the intensity distribution of the laser light deflected by the light scanner 4 so that the laser light that passes therethrough forms a predetermined light pattern on the image plane 9 by this means.

The optical path length pattern or the transmittance pattern of each of the plurality of diffractive optical element components 10 is optimized, for example, by an iterative Fourier transform method. The intensity distribution or the phase distribution of the laser light in each of the plurality of diffractive optical element components 10 and the light pattern formed on the image plane 9 have a Fourier transform relationship. Therefore, by performing inverse Fourier transform on a desired light pattern, the intensity distribution or the phase distribution of the laser light in each of the plurality of diffractive optical element components 10 is obtained.

However, the intensity distribution or the phase distribution of the laser light that can be realized in each of the plurality of diffractive optical element components 10 has a constraint associated with the intensity distribution or the phase distribution of incident laser light incident on each of the plurality of diffractive optical element components 10, and the intensity distribution or the phase distribution of the laser light in each of the plurality of diffractive optical element components 10 that meets the constraint cannot be obtained by a simple inverse Fourier transform.

Therefore, the intensity distribution or the phase distribution of the laser light in each of the plurality of diffractive optical element components 10 is optimized so as to meet the constraint by the Fourier transform repeatedly performed on the basis of the iterative Fourier transform method. The optical path length pattern or the transmittance pattern of each of the plurality of diffractive optical element components 10 is set on the basis of the obtained intensity distribution or phase distribution.

Next, an operation of the light pattern generation device 100 according to the first embodiment is described. Note that the control unit 8 controls each of the laser driver 2 and the light scanner driver 6 on the basis of information stored in an internal memory not illustrated or externally input information.

First, on the basis of a command from the control unit 8, the light scanner driver 6 controls the light scanner 4 so that the light scanner 4 changes the deflection direction in which the laser light emitted from the condensing optical system 3 is deflected to a first deflection direction toward a first diffractive optical element component out of the plurality of diffractive optical element components 10. The light scanner 4 changes the deflection direction in which the laser light emitted from the condensing optical system 3 is deflected to the first deflection direction on the basis of a command from the light scanner driver 6.

Next, the laser driver 2 controls the laser light source 1 so that the laser light source 1 emits the laser light on the basis of the command from the control unit 8. The laser light source 1 emits the laser light on the basis of a command from the laser driver

Next, the condensing optical system 3 converts the laser light emitted from the laser light source 1 into light to be condensed on the image plane 9. Next, the light scanner 4 deflects the laser light emitted from the condensing optical system 3 toward the first diffractive optical element component out of the plurality of diffractive optical element components 10.

Next, the first diffractive optical element component out of the plurality of diffractive optical element components 10 modulates at least one of the phase distribution or the intensity distribution of the laser light deflected by the light scanner 4 so that the laser light that passes therethrough forms a first light pattern on the image plane 9. Next, the laser light that passes through the first diffractive optical element component out of the plurality of diffractive optical element components 10 forms the first light pattern on the image plane 9.

Next, the laser driver 2 controls the laser light source 1 so that the laser light source 1 stops the emission of the laser light on the basis of the command from the control unit 8. The laser light source 1 stops the emission of the laser light on the basis of the command from the laser driver 2.

Next, on the basis of the command from the control unit 8, the light scanner driver 6 controls the light scanner 4 so that the light scanner 4 changes the deflection direction in which the laser light emitted from the laser light source 1 is deflected to a second deflection direction toward a second diffractive optical element component out of the plurality of diffractive optical element components 10. The light scanner 4 changes the deflection direction in which the laser light emitted from the laser light source 1 is deflected to the second deflection direction on the basis of the command from the light scanner driver 6.

Next, the laser driver 2 controls the laser light source 1 so that the laser light source 1 emits the laser light on the basis of the command from the control unit 8. The laser light source 1 emits the laser light on the basis of a command from the laser driver 2.

Next, the condensing optical system 3 converts the laser light emitted from the laser light source 1 into light to be condensed on the image plane 9. Next, the light scanner 4 deflects the laser light emitted from the condensing optical system 3 toward the second diffractive optical element component out of the plurality of diffractive optical element components 10.

Next, the second diffractive optical element component out of the plurality of diffractive optical element components 10 modulates at least one of the phase distribution or the intensity distribution of the laser light deflected by the light scanner 4 so that the laser light that passes therethrough forms a second light pattern on the image plane 9. Next, the laser light that passes through the second diffractive optical element component out of the plurality of diffractive optical element components 10 forms the second light pattern on the image plane 9.

In the light pattern generation device 100, by repeating the above-described operation, the diffractive optical element component through which the laser light deflected by the light scanner 4 passes is continuously switched among the plurality of diffractive optical element components 10, so that animation is displayed on the image plane 9.

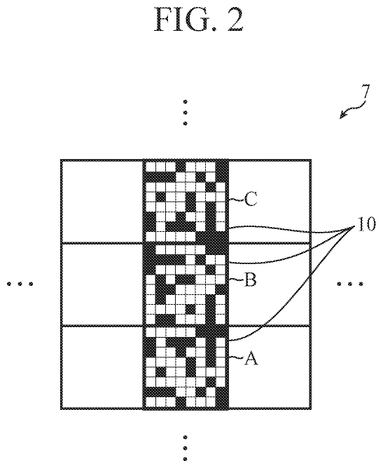

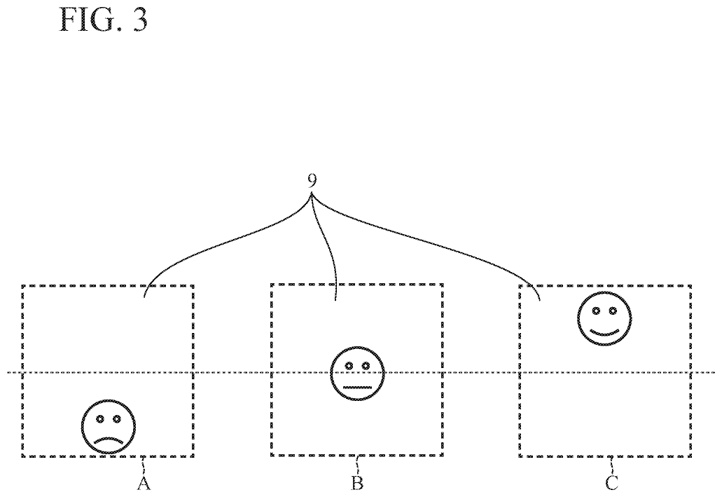

Next, a specific example of the operation of the light pattern generation device 100 according to the first embodiment is described. FIG. 2 is a diagram illustrating the configuration of the diffractive optical element unit 7. FIG. 3 is a diagram illustrating the light patterns formed on the image plane 9 by the laser light that passes through the plurality of diffractive optical element components 10 in the diffractive optical element unit 7 illustrated in FIG. 2.

As illustrated in FIG. 2, each of the plurality of diffractive optical element components 10 includes a plurality of periodically divided minute portions, and at least one of the optical path length or the transmittance is set in each of the plurality of portions so that the laser light that passes through the diffractive optical element component to which this belongs forms a predetermined light pattern on the image plane 9. That is, in each of the plurality of diffractive optical element components 10, at least one of the optical path length pattern or the transmittance pattern is set so that the laser light that passes therethrough forms a predetermined light pattern on the image plane 9.

As illustrated in FIGS. 2 and 3, a predetermined light pattern formed on the image plane 9 by the laser light, at least one of the phase distribution or the intensity distribution thereof is modulated by the diffractive optical element component indicated by A of FIG. 2, is the light pattern indicated by A of FIG. 3. A predetermined light pattern formed on the image plane 9 by the laser light, at least one of the phase distribution or the intensity distribution thereof is modulated by the diffractive optical element component indicated by B of FIG. 2, is the light pattern indicated by B of FIG. 3. A predetermined light pattern formed on the image plane 9 by the laser light, at least one of the phase distribution or the intensity distribution thereof is modulated by the diffractive optical element component indicated by C of FIG. 2, is the light pattern indicated by C of FIG. 3.

Then, as described above, by continuously switching the diffractive optical element component through which the laser light deflected by the light scanner 4 passes among the plurality of diffractive optical element components 10, animation in which a displayed light pattern is switched among the light pattern indicated by A of FIG. 3, the light pattern indicated by B of FIG. 3, and the light pattern indicated by C of FIG. 3 is displayed on the image plane 9.

As described above, the light pattern generation device 100 according to the first embodiment is provided with the laser light source 1 that emits the laser light, the light scanner 4 that deflects the laser light emitted from the laser light source 1, and the diffractive optical element unit 7 including the plurality of diffractive optical element components 10 each of which modulates at least one of the phase distribution or the intensity distribution of the laser light deflected by the light scanner 4 so that the laser light that passes therethrough forms a predetermined light pattern on the image plane 9, in which the light scanner 4 can change the deflection direction in which the laser light emitted from the laser light source 1 is deflected so that the laser light emitted from the laser light source 1 is deflected toward a predetermined diffractive optical element component out of the plurality of diffractive optical element components 10.

According to the above-described configuration, the light scanner 4 can deflect the laser light emitted from the laser light source 1 toward a predetermined diffractive optical element component out of the plurality of diffractive optical element components 10. That is, it is possible to switch the diffractive optical element component through which the laser light deflected by the light scanner 4 passes among the plurality of diffractive optical element components 10. Therefore, flexibility of order of the displayed light patterns can be improved.

For example, in the diffractive optical element unit 7 illustrated in FIG. 2, the diffractive optical element component through which the laser light deflected by the light scanner 4 passes is switched from the diffractive optical element component indicated by A to the diffractive optical element component indicated by B, then the diffractive optical element component through which the laser light deflected by the light scanner 4 passes is switched from the diffractive optical element component indicated by B to the diffractive optical element component indicated by A. In this manner, by switching the diffractive optical element component through which the laser light deflected by the light scanner 4 passes, the light pattern indicated by A of FIG. 3 and the light pattern indicated by B of FIG. 3 are alternately displayed. That is, only the light pattern of a displeased face is displayed.

Alternatively, in the diffractive optical element unit 7 illustrated in FIG. 2, the diffractive optical element component through which the laser light deflected by the light scanner 4 passes is switched from the diffractive optical element component indicated by B to the diffractive optical element component indicated by C, then the diffractive optical element component through which the laser light deflected by the light scanner 4 passes is switched from the diffractive optical element component indicated by C to the diffractive optical element component indicated by B. In this manner, by switching the diffractive optical element component through which the laser light deflected by the light scanner 4 passes, the light pattern indicated by B of FIG. 3 and the light pattern indicated by C of FIG. 3 are alternately displayed. That is, only the light pattern of a pleased face is displayed.

Alternatively, in the diffractive optical element unit 7 illustrated in FIG. 2, the diffractive optical element component through which the laser light deflected by the light scanner 4 passes may be switched from the diffractive optical element component indicated by B to any one of upper right, right, lower right, upper left, left, and lower left diffractive optical element components relative to this diffractive optical element component. As described above, the light pattern generation device 100 according to the first embodiment can switch the diffractive optical element component through which the laser light deflected by the light scanner 4 passes. Therefore, flexibility of order of the displayed light patterns can be improved.

The conventional light pattern generation device has a problem that it is difficult to downsize because this uses a configuration to rotate the diffractive optical element having a relatively large size in order to switch the displayed light pattern as described above. However, the light pattern generation device 100 according to the first embodiment uses a configuration in which the laser light is deflected by the light scanner 4 in order to switch the displayed light pattern. As a result, the light pattern generation device 100 according to the first embodiment can be downsized from the conventional light pattern generation device.

The light pattern generation device 100 according to the first embodiment is further provided with the light scanner driver 6 that controls the deflection direction of the light scanner 4 and the timing at which the deflection direction of the light scanner 4 is changed so that the light scanner 4 deflects the laser light emitted from the laser light source 1 toward a predetermined diffractive optical element component out of the plurality of diffractive optical element components 10 at a predetermined timing.

According to the above-described configuration, the deflection direction in which the laser light emitted from the laser light source 1 is deflected can be changed to a desired deflection direction at a desired timing. That is, among the plurality of diffractive optical element components 10, it is possible to switch the diffractive optical element component through which the laser light deflected by the light scanner 4 passes to a desired diffractive optical element component at a desired timing. Therefore, flexibility of order of the displayed light patterns can be improved.

In the light pattern generation device 100 according to the first embodiment, the condensing optical system 3 that converts the laser light emitted from the laser light source 1 into the light to be condensed on the image plane 9 is mounted between the laser light source 1 and the light scanner 4.

According to the above-described configuration, the light pattern can be suitably displayed on the image plane 9.

In each of the plurality of diffractive optical element components 10 in the light pattern generation device 100 according to the first embodiment, at least one of the optical path length pattern or the transmittance pattern is set so that the laser light that passes therethrough forms a predetermined light pattern on the image plane 9.

According to the above-described configuration, a predetermined light pattern can be suitably displayed on the image plane 9.

### Second Embodiment

In the light pattern generation device 100 according to the first embodiment, the light scanner 4 deflects the laser light, so that an incident angle of the laser light with respect to the diffractive optical element unit 7 varies depending on the deflection direction of the light scanner 4. Therefore, as illustrated in FIG. 3, there is a problem that positions of the displayed light patterns are different from each other on the image plane 9. In a light pattern generation device according to a second embodiment, in order to solve the problem, a diffractive optical element unit with a compensation structure having a different configuration from the configuration of the diffractive optical element unit 7 according to the first embodiment is used.

Hereinafter, the second embodiment is described with reference to the drawings. Note that a component having a function similar to that in the component described in the first embodiment is assigned with the same reference sign, and description thereof is not repeated.

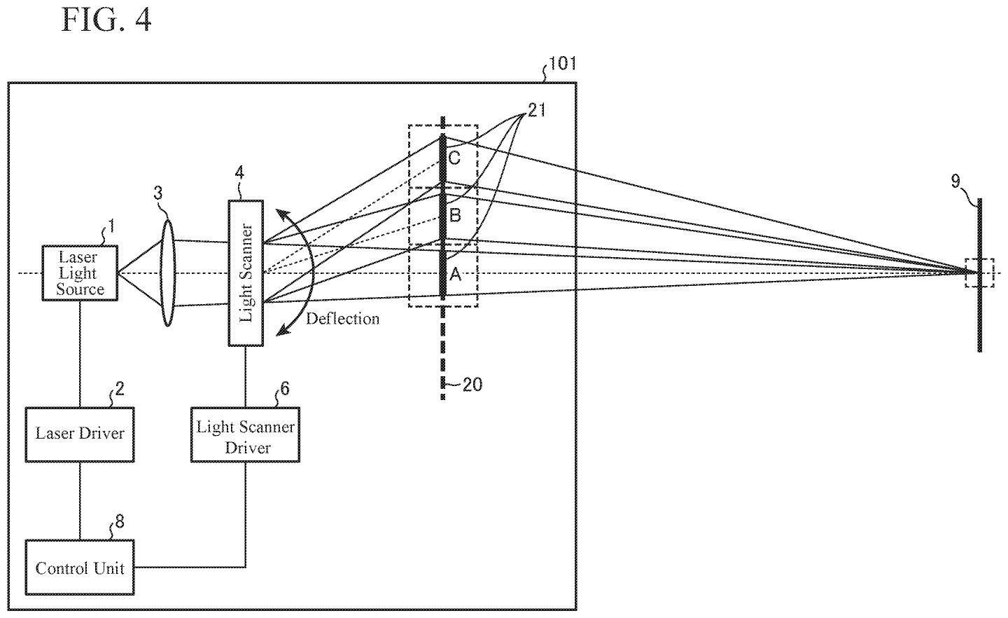

FIG. 4 is a diagram illustrating a configuration of a light pattern generation device 101 according to the second embodiment. The light pattern generation device 101 has a configuration similar to the configuration of the light pattern generation device 100 according to the first embodiment except that a diffractive optical element unit 20 is provided in place of the diffractive optical element unit 7.

The diffractive optical element unit 20 includes a plurality of diffractive optical element components 21 each of which modulates at least one of phase distribution or intensity distribution of laser light deflected by a light scanner 4 so that the laser light that passes therethrough forms a predetermined light pattern on an image plane 9. Furthermore, a pitch of each of the plurality of diffractive optical element components 21 according to the second embodiment is set so that the laser light that passes therethrough forms a predetermined light pattern in the same position on the image plane 9. Note that “the same position” in this specification means substantially the same position, completely the same position, substantially constant position, or completely constant position.

A light scanner driver 6 according to the second embodiment controls a deflection direction of the light scanner 4 and a timing at which the deflection direction of the light scanner 4 is changed so that animation is displayed in the same position on the image plane 9 by continuously changing the diffractive optical element component through which the laser light deflected by the light scanner 4 passes among the plurality of diffractive optical element components 21.

Hereinafter, the configuration of the diffractive optical element unit 20 is described in detail. In each of the plurality of diffractive optical element components 21 in the diffractive optical element unit 20, at least one of an optical path length pattern or a transmittance pattern is set so that the laser light that passes therethrough forms a predetermined light pattern on the image plane 9.

More specifically, each of the plurality of diffractive optical element components 21 includes a plurality of periodically divided minute portions, and at least one of the optical path length or the transmittance is set in each of the plurality of portions so that the laser light that passes through the diffractive optical element component to Which this belongs forms a predetermined light pattern on the image plane 9. In the second embodiment, in addition to this configuration, in each of the plurality of diffractive optical element components 21, the pitch, which is a width of each portion of the above-described plurality of portions, is further set so that the laser light that passes therethrough forms a predetermined light pattern in the same position on the image plane 9. Note that the width herein is the width in a direction parallel to an incident surface and an emission surface of the laser light in the diffractive optical element unit 20.

In further detail, each of the plurality of diffractive optical element components 21 has a periodic structure, so that this is approximately treated as a diffractive grating, For example, in a case Where each of the plurality of diffractive optical element components 21 is assumed as a one-dimensional diffractive grating, the following equation (1) holds between an incident angle θin and an emission angle θout of the laser light with respect to each diffractive optical element component out of the plurality of diffractive optical element components 21.

$$sin ( θ in ) = m λ \text{/} p - sin ( θ out ) \qquad ( 1 )$$

where m represents a diffraction order of each of the plurality of diffractive optical element components 21, λ represents a wavelength of the laser light, and p represents the above-described pitch. In addition, θin represents an angle formed from a normal of an incident surface of each of the plurality of diffractive optical element components 21, and θout represents an angle formed from a normal of an emission surface of each of the plurality of diffractive optical element components 21.

As illustrated in FIG. 4, the incident angle of the laser light incident on each of the plurality of diffractive optical element components 21 is different for each diffractive optical element component. The emission angle of the laser light emitted from each of the plurality of diffractive optical element components 21 needs to be set so that the positions of the light patterns formed on the image plane 9 by the laser light emitted from the plurality of diffractive optical element components 21 coincide with each other. Therefore, it is understood that it is necessary to appropriately set mλ/p for each diffractive optical element component for the incident angle and the emission angle to satisfy the relationship of equation (1) described above. Since m and λ usually have no degree of freedom, this results in a problem of optimizing a pitch p.

In practice, each of the plurality of diffractive optical element components 21 has a two-dimensional structure, and the transmittance pattern and the optical path length pattern of each of them are not necessarily periodic, so that equation (1) assuming each of the plurality of diffractive optical element components 21 as the one-dimensional diffractive grating does not strictly hold. However, according to the above-described concept, by optimizing the pitch of each of the plurality of diffractive optical element components 21 in addition to at least one of the transmittance pattern or the optical path length pattern of each of the plurality of diffractive optical element components 21, it is possible to make the positions of the light patterns formed on the image plane 9 by the laser light transmitted through the plurality of diffractive optical element components 21 coincide with each other.

Note that an operation of the light pattern generation device 101 according to the second embodiment is similar to the operation of the light pattern generation device 100 according to the first embodiment except that the position on the image plane 9 where the laser light that passes through a first diffractive optical element component out of the plurality of diffractive optical element components 21 forms a first light pattern coincides with the position on the image plane 9 where the laser light that passes through a second diffractive optical element component out of the plurality of diffractive optical element components 21 forms a second light pattern.

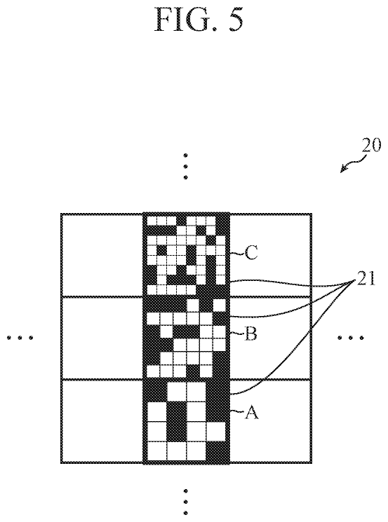

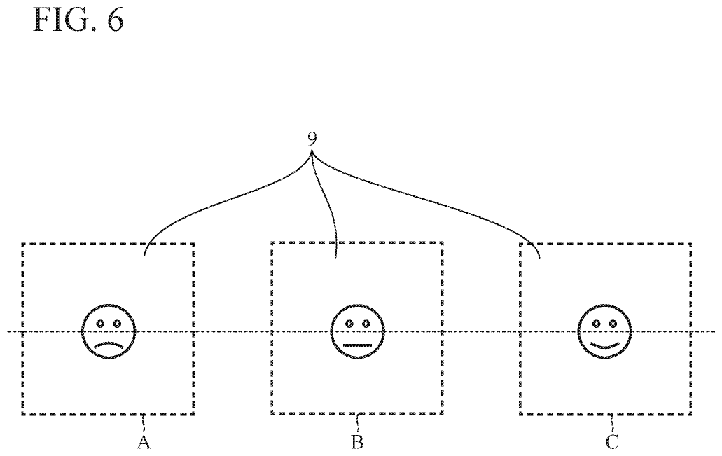

Next, a specific example of the operation of the light pattern generation device 101 according to the second embodiment is described. FIG. 5 is a diagram illustrating a configuration of the diffractive optical element unit 20. FIG. 6 is a diagram illustrating light patterns formed on the image plane 9 by the laser light that passes through the plurality of diffractive optical element components 21 in the diffractive optical element unit 20 illustrated in FIG. 5.

As illustrated in FIG. 5, each of the plurality of diffractive optical element components 21 includes a plurality of periodically divided minute portions, and at least one of the optical path length or the transmittance is set in each of the plurality of portions so that the laser light that passes through the diffractive optical element component to which this belongs forms a predetermined light pattern on the image plane 9. Furthermore, in each of the plurality of diffractive optical element components 21, the pitch, which is a width of each portion of the above-described plurality of portions, is set so that the laser light that passes therethrough forms a predetermined light pattern in the same position on the image plane 9. Note that the width herein is the width in a direction parallel to an incident surface and an emission surface of the laser light in the diffractive optical element unit 20. For example, the pitch of the diffractive optical element component indicated by A of FIG. 5 is larger than the pitch of the diffractive optical element component indicated by B of FIG. 5 and the pitch of the diffractive optical element component indicated by C of FIG. 5.

As illustrated in FIGS. 5 and 6, a predetermined light pattern formed on the image plane 9 by the laser light, at least one of the phase distribution or the intensity distribution thereof is modulated by the diffractive optical element component indicated by A of FIG. 5, is the light pattern indicated by A of FIG. 6. A predetermined light pattern formed on the image plane 9 by the laser light, at least one of the phase distribution or the intensity distribution thereof is modulated by the diffractive optical element component indicated by B of FIG. 5, is the light pattern indicated by B of FIG. 6. A predetermined light pattern formed on the image plane 9 by the laser light, at least one of the phase distribution or the intensity distribution thereof is modulated by the diffractive optical element component indicated by C of FIG. 5, is the light pattern indicated by C of FIG. 6.

As indicated by the light patterns A, B, and C in FIG. 6, the laser light that passes through each of the plurality of diffractive optical element components 21 forms a predetermined light pattern in the same position on the image plane 9. Then, as described above, by continuously switching the diffractive optical element component through which the laser light deflected by the light scanner 4 passes among the plurality of diffractive optical element components 21, animation in which a displayed light pattern is switched among the light pattern indicated by A of FIG. 6, the light pattern indicated by B of FIG. 6, and the light pattern indicated by C of FIG. 6 is displayed on the image plane 9.

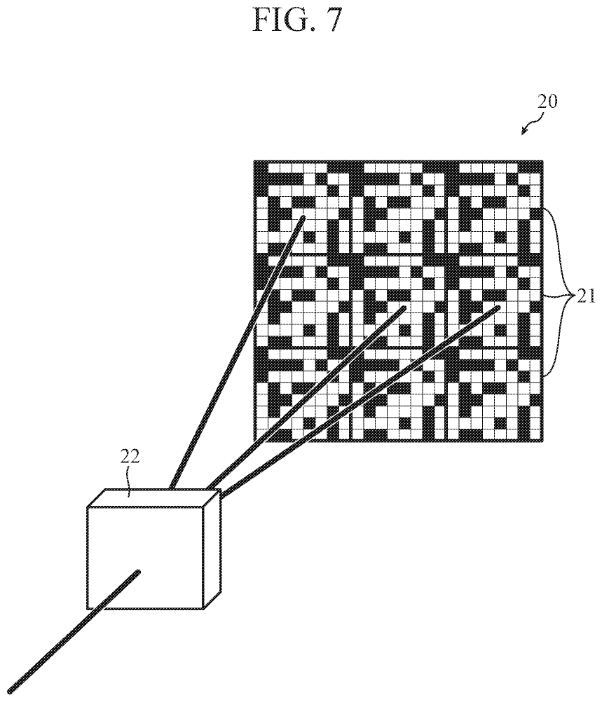

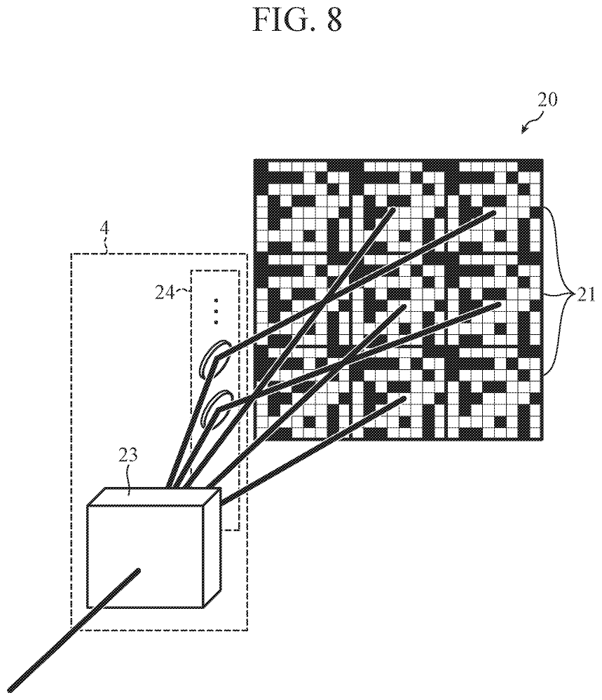

Next, a specific example of the light scanner 4 of the light pattern generation device 101 according to the second embodiment is described with reference to the drawings. FIG. 7 is a diagram illustrating an example in which a two-dimensional scan element 22 is used as the light scanner 4. FIG. 8 is a diagram illustrating an example in which a one-dimensional scan element 23 and an addressing optical system 24 are used as the light scanner 4.

In the example illustrated in FIG. 7, the light scanner 4 is the two-dimensional scan element 22 capable of two-dimensionally changing the deflection direction in which the laser light emitted from the laser light source is deflected. As illustrated in FIG. 7, the two-dimensional scan element 22 can change the deflection direction in which the laser light emitted from the laser light source 1 is deflected so as to deflect the laser light emitted from the laser light source 1 toward a predetermined diffractive optical element component out of the plurality of diffractive optical element components 21 arranged two-dimensionally.

In the example illustrated in FIG. 8, the light scanner 4 includes the one-dimensional scan element 23 capable of one-dimensionally changing the deflection direction in which the laser light emitted from the laser light source 1 is deflected, and the addressing optical system 24 that two-dimensionally changes a propagation direction of the laser light deflected by the one-dimensional scan element 23 in a direction toward a predetermined diffractive optical element component out of the plurality of diffractive optical element components 21.

Note that the addressing optical system 24 illustrated in FIG. 8 includes a plurality of reflection mirrors. However, the addressing optical system 24 is not limited to this configuration. For example, the addressing optical system 24 may be a prism or the like. The two-dimensional scan element 22 illustrated in FIG. 7, and the one-dimensional scan element 23 and the addressing optical system 24 illustrated in FIG. 8 may be applied to the light pattern generation device 100 according to the first embodiment, a light pattern generation device according to a third embodiment described later, a light pattern generation device according to a fourth embodiment described later, or a light pattern generation device according to a fifth embodiment described later.

As described above, the pitch of each of the plurality of diffractive optical element components 21 in the light pattern generation device 101 according to the second embodiment is set so that the laser light that passes therethrough forms a predetermined light pattern in the same position on the image plane 9.

According to the above-described configuration, the laser light that passes through each of the plurality of diffractive optical element components 21 forms the light patterns in the same position on the image plane 9. As a result, it is possible to display animation in the same position on the image plane 9 by continuously switching the diffractive optical element component through which the laser light deflected by the light scanner 4 passes among the plurality of diffractive optical element components 21.

The light pattern generation device 101 according to the second embodiment is further provided with the light scanner driver 6 that controls the deflection direction of the light scanner 4 and the timing at which the deflection direction of the light scanner 4 is changed so that the light scanner 4 deflects the laser light emitted from the laser light source 1 toward a predetermined diffractive optical element component out of the plurality of diffractive optical element components 21 at a predetermined timing, in which the light scanner driver 6 controls the deflection direction of the light scanner 4 and the timing at which the deflection direction of the light scanner 4 is changed so that animation is displayed in the same position on the image plane 9 by continuously switching the diffractive optical element component through which the laser light deflected by the light scanner 4 passes among the plurality of diffractive optical element components 21.

According to the above-described configuration, the light scanner driver 6 controls the light scanner 4, so that the diffractive optical element component through which the laser light deflected by the light scanner 4 passes is continuously switched among the plurality of diffractive optical element components 21. As a result, animation can be displayed in the same position on the image plane 9.

The light scanner 4 in the light pattern generation device 101 according to the second embodiment includes the one-dimensional scan element 23 capable of one-dimensionally changing the deflection direction in which the laser light emitted from the laser light source 1 is deflected, and the addressing optical system 24 that two-dimensionally changes the propagation direction of the laser light deflected by the one-dimensional scan element 23 in the direction toward a predetermined diffractive optical element component out of the plurality of diffractive optical element components 21.

According to the above-described configuration, the one-dimensional scan element 23 can change the deflection direction in which the laser light emitted from the laser light source 1 is deflected so as to deflect the laser light emitted from the laser light source 1 toward a predetermined diffractive optical element component out of the plurality of diffractive optical element components 21 arranged two-dimensionally. Therefore, it is possible to switch the diffractive optical element component through which the laser light deflected by the one-dimensional scan element 23 passes among the plurality of diffractive optical element components 21 arranged two-dimensionally. Therefore, flexibility of order of the displayed light patterns can be improved.

### Third Embodiment

As described above, the light pattern generation device 100 according to the first embodiment has a problem that the positions of the displayed light pattern are different from each other on the image plane 9. In order to solve the problem, a light pattern generation device according to a third embodiment is further provided with an incident angle correction optical system and a re-condensing optical system.

Hereinafter, the third embodiment is described with reference to the drawings. Note that a component having a function similar to that in the component described in the first embodiment is assigned with the same reference sign, and description thereof is not repeated.

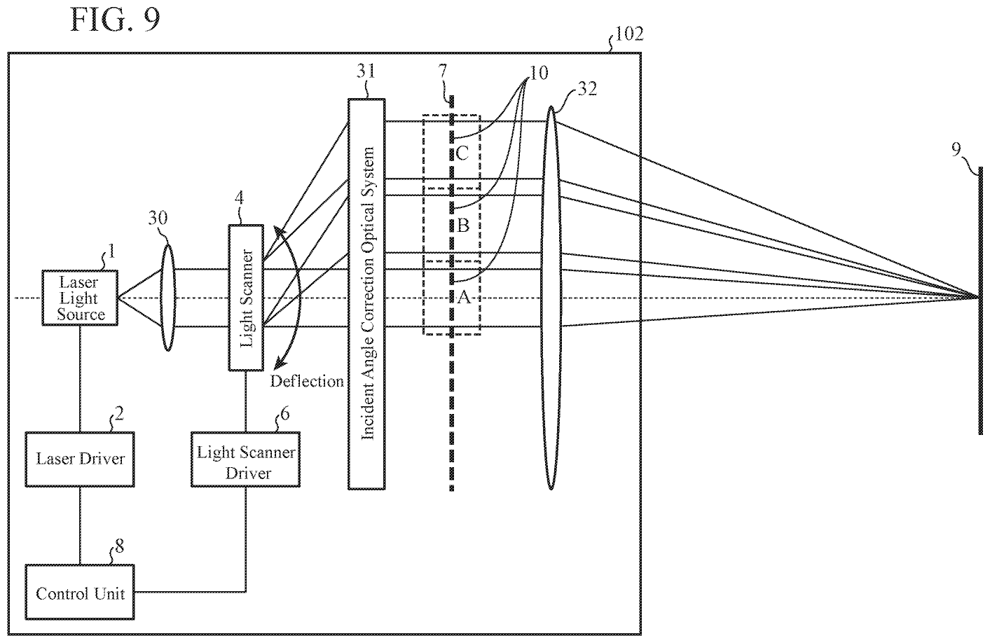

FIG. 9 is a diagram illustrating a configuration of a light pattern generation device 102 according to the third embodiment. As compared with the configuration of the light pattern generation device 100 according to the first embodiment, the light pattern generation device 102 is provided with a collimating optical system 30 in place of the condensing optical system 3. The light pattern generation device 102 is further provided with an incident angle correction optical system 31 and a re-condensing optical system 32.

The collimating optical system 30 is mounted between a laser light source 1 and a light scanner 4, The collimating optical system 30 converts laser light emitted from the laser light source into parallel light.

Note that, in a case where the laser light source 1 has a function of generating the parallel light, the light pattern generation device 102 need not be provided with the collimating optical system 30. As a result, the number of parts of the optical system can be reduced, so that cost reduction and downsizing can be achieved.

The light scanner 4 according to the third embodiment can change a deflection direction in which laser light emitted from the collimating optical system 30 is deflected so as to deflect the laser light emitted from the collimating optical system 30 toward a predetermined diffractive optical element component out of a plurality of diffractive optical element components 10. More specifically, the light scanner 4 can change the deflection direction in which the laser light emitted from the collimating optical system 30 is deflected so that the laser light emitted from the collimating optical system 30 is incident on a predetermined diffractive optical element component out of the plurality of diffractive optical element components 10 via the incident angle correction optical system 31 described later.

The incident angle correction optical system 31 is mounted between the light scanner 4 and the diffractive optical element unit 7. The incident angle correction optical system 31 converts the laser light deflected by the light scanner 4 into parallel light an incident angle of which with respect to a predetermined diffractive optical element component out of the plurality of diffractive optical element components 10 is constant independently of the deflection direction of the light scanner 4. Note that, herein, it is assumed that incident surfaces of the plurality of diffractive optical element components 10 are on the same plane, and emission surfaces of the plurality of diffractive optical element components 10 are on the same plane.

Each of the plurality of diffractive optical element components 10 in the diffractive optical element unit 7 according to the third embodiment modulates at least one of phase distribution or intensity distribution of the laser light incident from the incident angle correction optical system 31 at the same incident angle so that the laser light that passes therethrough forms a predetermined light pattern on an image plane 9. Note that the laser light that passes through each of the plurality of diffractive optical element components 10 is parallel light emitted at the same emission angle. That is, a pitch of each of the plurality of diffractive optical element components 10 in the diffractive optical element unit 7 according to the third embodiment is not set unlike that of the plurality of diffractive optical element components 21 according to the second embodiment.

The re-condensing optical system 32 is mounted between the diffractive optical element unit 7 and the image plane 9. The re-condensing optical system 32 condenses the laser light that passes through a predetermined diffractive optical element component out of the plurality of diffractive optical element components 10 in the same position on the image plane 9. More specifically, the re-condensing optical system 32 condenses the parallel light that passes through a predetermined diffractive optical element component out of the plurality of diffractive optical element components 10 in the same position on the image plane 9 independently of the diffractive optical element component through which this passes. The laser light that passes through the re-condensing optical system 32 forms a predetermined light pattern in the same position on the image plane 9 independently of the diffractive optical element component through which this passes. That is, since the position of the light pattern formed on the image plane 9 is determined by the re-condensing optical system 32, it is not necessary to set the pitch of each of the plurality of diffractive optical element components 10 as described above.

A light scanner driver 6 according to the third embodiment controls a deflection direction of the light scanner 4 and a timing at which the deflection direction of the light scanner 4 is changed so that animation is displayed in the same position on the image plane 9 by continuously switching the diffractive optical element component through which the laser light emitted from the incident angle correction optical system 31 passes among the plurality of diffractive optical element components 10.

Next, an operation of the light pattern generation device 102 according to the third embodiment is described. Note that the control unit 8 controls each of the laser driver 2 and the light scanner driver 6 on the basis of information stored in an internal memory not illustrated or externally input information.

First, the light scanner driver 6 controls the light scanner 4 so that the light scanner 4 changes the deflection direction in which the laser light emitted from the collimating optical system 30 is deflected to a first deflection direction on the basis of a command from the control unit 8. The light scanner 4 changes the deflection direction in which the laser light emitted from the collimating optical system 30 is deflected to the first deflection direction on the basis of a command from the light scanner driver 6. Note that the laser light deflected in the first deflection direction by the light scanner 4 is incident on the first diffractive optical element component out of the plurality of diffractive optical element components 10 via the incident angle correction optical system 31.

Next, the laser driver 2 controls the laser light source 1 so that the laser light source 1 emits the laser light on the basis of the command from the control unit 8. The laser light source 1 emits the laser light on the basis of a command from the laser driver 2.

The collimating optical system 30 converts the laser light emitted from the laser light source into parallel light. Next, the light scanner 4 deflects the laser light in the first deflection direction so that the laser light emitted from the collimating optical system 30 is incident on the first diffractive optical element component out of the plurality of diffractive optical element components 10 via the incident angle correction optical system 31.

Next, the incident angle correction optical system 31 converts the laser light deflected by the light scanner 4 into parallel light incident on the first diffractive optical element component out of the plurality of diffractive optical element components 10.

Next, the first diffractive optical element component out of the plurality of diffractive optical element components 10 modulates at least one of the phase distribution or the intensity distribution of the laser light emitted from the incident angle correction optical system 31 so that the laser light that passes therethrough forms a first light pattern on the image plane 9.

Next, the re-condensing optical system 32 condenses the laser light that passes through the first diffractive optical element component out of the plurality of diffractive optical element components 10 on the image plane 9. Next, the laser light emitted from the re-condensing optical system 32 forms the first light pattern on the image plane 9.

Next, the laser driver 2 controls the laser light source 1 so that the laser light source 1 stops the emission of the laser light on the basis of the command from the control unit 8. The laser light source 1 stops the emission of the laser light on the basis of the command from the laser driver 2.

Next, the light scanner driver 6 controls the light scanner 4 so that the light scanner 4 changes the deflection direction in which the laser light emitted from the collimating optical system 30 is changed to a second deflection direction on the basis of a command from the control unit 8. The light scanner 4 changes the deflection direction in which the laser light emitted from the collimating optical system 30 is deflected to the second deflection direction on the basis of the command from the light scanner driver 6. Note that the laser light deflected in the second deflection direction by the light scanner 4 is incident on a second diffractive optical element component out of the plurality of diffractive optical element components 10 via the incident angle correction optical system 31.

Next, the laser driver 2 controls the laser light source 1 so that the laser light source 1 emits the laser light on the basis of the command from the control unit 8. The laser light source 1 emits the laser light on the basis of a command from the laser driver 2.

Next, the collimating optical system 30 converts the laser light emitted from the laser light source 1 into parallel light. Next, the light scanner 4 deflects the laser light in the second deflection direction so that the laser light emitted from the collimating optical system 30 is incident on the first diffractive optical element component out of the plurality of diffractive optical element components 10 via the incident angle correction optical system 31.

Next, the incident angle correction optical system 31 converts the laser light deflected by the light scanner 4 into parallel light incident on the second diffractive optical element component out of the plurality of diffractive optical element components 10. Note that the incident angle of the parallel light incident on the first diffractive optical element component described above and the incident angle of the parallel light incident on the second diffractive optical element component coincide with each other.

Next, the second diffractive optical element component out of the plurality of diffractive optical element components 10 modulates at least one of the phase distribution or the intensity distribution of the laser light emitted from the incident angle correction optical system 31 so that the laser light that passes therethrough forms a second light pattern on the image plane 9.

Next, the re-condensing optical system 32 condenses the laser light that passes through the second diffractive optical element component out of the plurality of diffractive optical element components 10 on the image plane 9. Next, the laser light emitted from the re-condensing optical system 32 forms the second light pattern on the image plane 9. Note that the position of the above-described first light pattern formed on the image plane 9 coincides with the position of the second light pattern formed on the image plane 9.

In the light pattern generation device 102, by repeating the above-described operation, the diffractive optical element component through which the laser light emitted from the incident angle correction optical system 31 passes is continuously switched among the plurality of diffractive optical element components 10, so that animation is displayed on the image plane 9.

Next, a first specific example of the incident angle correction optical system 31 according to the third embodiment is described. FIG. 10 is a diagram illustrating a configuration of the first specific example of the incident angle correction optical system 31.

As illustrated in FIG. 10, the incident angle correction optical system 31 according to the first specific example includes a telecentric optical system 33 and a collimating optical system array 34.

The telecentric optical system 33 makes a principal light beam of the laser light deflected by the light scanner 4 parallel to an optical axis. Note that, in FIG. 10, the telecentric optical system 33 is illustrated as a lens, but is not limited to this configuration. In order to make the principal light beam of the laser light deflected by the light scanner 4 parallel to the optical axis, the telecentric optical system 33 may be a mirror and the like that reflects the laser light.

The collimating optical system array 34 converts the laser light the principal light beam of which is made parallel to the optical axis by the telecentric optical system 33 into parallel light. More specifically, the collimating optical system array 34 includes a plurality of collimating optical systems, and each of the plurality of collimating optical systems converts the laser light the principal light beam of which is made parallel to the optical axis by the telecentric, optical system 33 into the parallel light. Note that, in FIG. 10, the collimating optical system array 34 is illustrated as a convex lens array, but is not limited to this configuration. The collimating optical system array 34 may be a concave lens array that converts the laser light the principal light beam of which is made parallel to the optical axis by the telecentric optical system 33 into the parallel light.

Alternatively, the collimating optical system array 34 may be a reflection mirror array that reflects the laser light so as to convert the laser light the principal light beam of which is made parallel to the optical axis by the telecentric optical system 33 into the parallel light.

As for a configuration of each of the telecentric optical system 33 and the collimating optical system array 34, more specifically, as illustrated in FIG. 10, an interval between an emission surface of the light scanner 4 and an incident surface of the telecentric optical system 33 coincides with a focal length f₁ of the telecentric optical system 33. As a result, the principal light beam of the laser light emitted from the telecentric optical system 33 becomes parallel to the optical axis of the telecentric optical system 33.

As illustrated in FIG. 10, an interval between an emission surface of the telecentric optical system 33 and each incident surface of the collimating optical system array 34 coincides with the sum of the focal length f₁ of the telecentric optical system 33 and each focal length f₂ of the collimating optical system array 34. As a result, each laser light emitted from the collimating optical system array 34 becomes the parallel light.

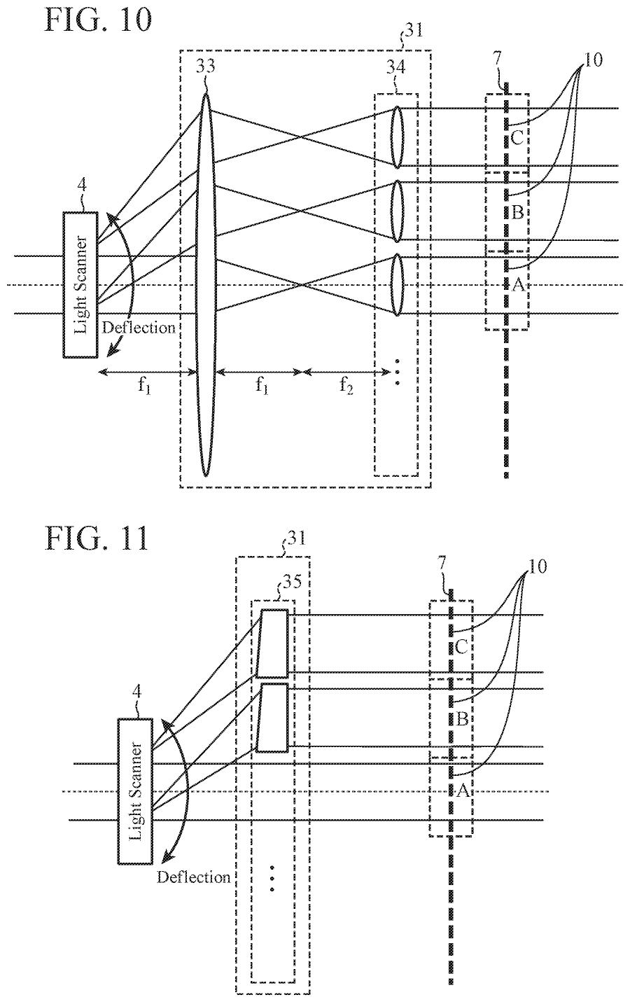

Next, a second specific example of the incident angle correction optical system 31 according to the third embodiment is described. FIG. 11 is a diagram illustrating a configuration of the second specific example of the incident angle correction optical system 31.

As illustrated in FIG. 11, the incident angle correction optical system 31 according to the second specific example includes a prism array 35. The prism array 35 converts the laser light deflected by the light scanner 4 into parallel light an incident angle of which with respect to a predetermined diffractive optical element component out of the plurality of diffractive optical element components 10 is constant independently of the deflection direction of the light scanner 4, Note that it is assumed that optical axes of the prism array 35 are parallel.

As described above, in the light pattern generation device 102 according to the third embodiment, the incident angle correction optical system 31 that converts the laser light deflected by the light scanner 4 into the parallel light the incident angle of which with respect to a predetermined diffractive optical element component out of the plurality of diffractive optical element components 10 is constant independently of the deflection direction of the light scanner 4 is mounted between the light scanner 4 and the diffractive optical element unit 7, and the re-condensing optical system 32 that condenses the laser light that passes through a predetermined diffractive optical element component out of the plurality of diffractive optical element components 10 in the same position on the image plane 9 is mounted between the diffractive optical element unit 7 and the image plane 9.

According to the above-described configuration, the laser light that passes through the re-condensing optical system 32 forms the light pattern in the same position on the image plane 9. As a result, it is possible to display animation in the same position on the image plane 9 by continuously switching the diffractive optical element component through which the laser light passes among the plurality of diffractive optical element components 10.

According to the above-described configuration, it is not necessary to adjust the pitch of each of the plurality of diffractive optical element components 10 unlike in the second embodiment in order to display the light pattern in the same position on the image plane 9. Therefore, a cost required for designing and manufacturing the plurality of diffractive optical element components 10 can be reduced.

According to the above-described configuration, the laser light incident on a predetermined diffractive optical element component out of the plurality of diffractive optical element components 10 is the parallel light the incident angle of which is constant independently of the deflection direction of the light scanner 4. As a result, in a case where the diffractive optical element unit 7 includes a plurality of diffractive optical elements, an arrangement position of each of the plurality of diffractive optical element components 10 can be changed even after the diffractive optical element unit 7 is manufactured. Alternatively, it is possible to replace at least one or more diffractive optical element components out of the plurality of diffractive optical element components 10 with other diffractive optical element components. For example, it is possible to display the light pattern depending on a situation or an application on the image plane 9 by preparing a large number of other diffractive optical elements, removing at least one or more diffractive optical element components out of the plurality of diffractive optical element components 10 and adding other diffractive optical elements depending on a situation or an application.

The incident angle correction optical system 31 in the light pattern generation device 102 according to the third embodiment includes the telecentric optical system 33 that makes the principal light beam of the laser light deflected by the light scanner 4 parallel to the optical axis, and the collimating optical system array 34 each of which converts the laser light the principal light beam of which is made parallel to the optical axis by the telecentric optical system 33 into the parallel light.

According to the above-described configuration, the laser light deflected by the light scanner 4 is suitably converted into the parallel light the incident angle of which with respect to a predetermined diffractive optical element component out of the plurality of diffractive optical element components 10 is constant independently of the deflection direction of the light scanner 4 by the incident angle correction optical system 31 and the collimating optical system array 34. Then, the laser light that passes through the re-condensing optical system 32 forms the light pattern in the same position on the image plane 9. As a result, it is possible to display animation in the same position on the image plane 9 by continuously switching the diffractive optical element component through which the laser light passes among the plurality of diffractive optical element components 10.

The incident angle correction optical system 31 in the light pattern generation device 102 according to the third embodiment includes the prism array 35 that converts the laser light deflected by the light scanner 4 into the parallel light the incident angle of which with respect to a predetermined diffractive optical element component out of the plurality of diffractive optical element components 10 is constant independently of the deflection direction of the light scanner 4.

According to the above-described configuration, the laser light deflected by the light scanner 4 is suitably converted into the parallel light the incident angle of which with respect to a predetermined diffractive optical element component out of the plurality of diffractive optical element components 10 is constant independently of the deflection direction of the light scanner 4, by the prism array 35. Then, the laser light that passes through the re-condensing optical system 32 forms the light pattern in the same position on the image plane 9. As a result, it is possible to display animation in the same position on the image plane 9 by continuously switching the diffractive optical element component through which the laser light passes among the plurality of diffractive optical element components 10. Since the number of optical systems can be reduced as compared with a case where the incident angle correction optical system 31 and the collimating optical system array 34 are used, downsizing of the light pattern generation device 102 can be achieved.

The light pattern generation device 102 according to the third embodiment is further provided with the light scanner driver 6 that controls the deflection direction of the light scanner 4 and the timing at which the deflection direction of the light scanner 4 is changed so that the light scanner 4 deflects the laser light emitted from the laser light source 1 toward a predetermined diffractive optical element component out of the plurality of diffractive optical element components 10 at a predetermined timing, in which the light scanner driver 6 controls the deflection direction of the light scanner 4 and the timing at which the deflection direction of the light scanner 4 is changed so that animation is displayed in the same position on the image plane 9 by continuously switching the diffractive optical element component through which the laser light emitted from the incident angle correction optical system 31 passes among the plurality of diffractive optical element components 10.

According to the above-described configuration, when the light scanner driver 6 controls the light scanner 4, the diffractive optical element component through which the laser light emitted from the incident angle correction optical system 31 passes is continuously switched among the plurality of diffractive optical element components 10. As a result, animation can be displayed in the same position on the image plane 9.

### Fourth Embodiment

In the third embodiment, the configuration in which the collimating optical system 30 is mounted between the laser light source 1 and the light scanner 4 is described. In a fourth embodiment, a configuration in which a light scanner condensing optical system is mounted between the laser light source 1 and the light scanner 4 is described.

Hereinafter, the fourth embodiments is described with reference to the drawings. Note that a component having a function similar to that in the component described in the first embodiment is assigned with the same reference sign, and description thereof is not repeated.

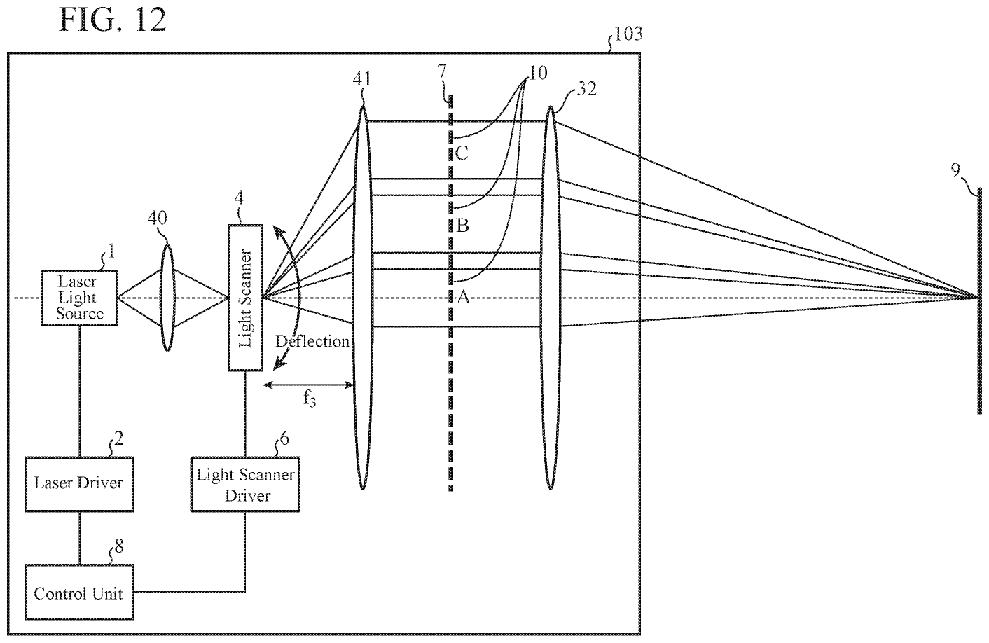

FIG. 12 is a diagram illustrating a configuration of a light pattern generation device 103 according to the fourth embodiment. As compared with the configuration of the light pattern generation device 100 according to the first embodiment, the light pattern generation device 103 is provided with a light scanner condensing optical system 40 in place of the condensing optical system 3. The light pattern generation device 103 is further provided with a light scanner collimating optical system 41 and a re-condensing optical system 32.

The light scanner condensing optical system 40 is mounted between the laser light source 1 and the light scanner 4. The light scanner condensing optical system 40 condenses the laser light emitted from the laser light source 1 on the light scanner 4. As a result, even in a case where an effective opening of the light scanner 4 is relatively small, the laser light can be incident on the light scanner 4, and vignetting can be suppressed.

Note that, in FIG. 12, the light scanner condensing optical system 40 is illustrated as a lens, but is not limited to this configuration. In order to condense the laser light emitted from the laser light source 1 on the light scanner 4, the light scanner condensing optical system 40 may be a mirror and the like that reflects the laser light. Alternatively, in a case where the laser light source 1 has a function of condensing the laser light on the light scanner 4, the light pattern generation device 103 need not be provided with the light scanner condensing optical system 40. As a result, the number of parts of the optical system can be reduced, so that cost reduction and downsizing can be achieved.

The light scanner 4 according to the fourth embodiment can change the deflection direction in which the laser light emitted from the light scanner condensing optical system 40 is deflected so as to deflect the laser light emitted from the light scanner condensing optical system 40 toward a predetermined diffractive optical element component out of the plurality of diffractive optical element components 10. More specifically, the light scanner 4 can change the deflection direction in which the laser light emitted from the light scanner condensing optical system 40 is deflected so that the laser light emitted from the light scanner condensing optical system 40 is incident on a predetermined diffractive optical element component out of the plurality of diffractive optical element components 10 via the light scanner collimating optical system 41 described later.

The light scanner collimating optical system 41 is mounted between the light scanner 4 and the diffractive optical element unit 7. The light scanner collimating optical system 41 converts the laser light deflected by the light scanner 4 into parallel light an incident angle of which with respect to a predetermined diffractive optical element component out of the plurality of diffractive optical element components 10 is constant independently of the deflection direction of the light scanner 4. Note that, herein, it is assumed that incident surfaces of the plurality of diffractive optical element components 10 are on the same plane, and emission surfaces of the plurality of diffractive optical element components 10 are on the same plane.

Note that, in FIG. 12, the light scanner collimating optical system 41 is illustrated as a lens, but is not limited to this configuration. The light scanner collimating optical system 41 may be a mirror and the like that reflects the laser light so as to convert the laser light deflected by the light scanner 4 into parallel light an incident angle of which with respect to a predetermined diffractive optical element component out of the plurality of diffractive optical element components 10 is constant independently of the deflection direction of the light scanner 4.

As for the configuration of the light scanner collimating optical system 41, more specifically, as illustrated in FIG. 12, an interval between the light scanner 4 and the light scanner collimating optical system 41 coincides with a focal length f₃ of the light scanner collimating optical system 41. As a result, each laser light emitted from the light scanner collimating optical system 41 becomes parallel light.

Each of the plurality of diffractive optical element components 10 in the diffractive optical element unit 7 according to the fourth embodiment modulates at least one of phase distribution or intensity distribution of the laser light incident from the light scanner collimating optical system 41 at the same incident angle so that the laser light that passes therethrough forces a predetermined light pattern on an image plane 9. Note that the laser light that passes through each of the plurality of diffractive optical element components 10 is parallel light emitted at the same emission angle.

The re-condensing optical system 32 according to the fourth embodiment is mounted between the diffractive optical element unit 7 and the image plane 9. The re-condensing optical system 32 condenses the laser light that passes through a predetermined diffractive optical element component out of the plurality of diffractive optical element components 10 in the same position on the image plane 9.

A light scanner driver 6 according to the fourth embodiment controls a deflection direction of the light scanner 4 and a timing at which the deflection direction of the light scanner 4 is changed so that animation is displayed in the same position on the image plane 9 by continuously switching the diffractive optical element component through which the laser light emitted from the light scanner collimating optical system 41 passes among the plurality of diffractive optical element components 10.

Next, an operation of the light pattern generation device 103 according to the fourth embodiment is described. Note that the control unit 8 controls each of the laser driver 2 and the light scanner driver 6 on the basis of information stored in an internal memory not illustrated or externally input information.

First, the light scanner driver 6 controls the light scanner 4 so that the light scanner 4 changes the deflection direction in which the laser light emitted from the light scanner condensing optical system 40 is deflected to a first deflection direction on the basis of a command from the control unit 8. The light scanner 4 changes the deflection direction in which the laser light emitted from the light scanner condensing optical system 40 is deflected to the first deflection direction on the basis of a command from the light scanner driver 6. Note that the laser light deflected in the first deflection direction by the light scanner 4 is incident on the first diffractive optical element component out of the plurality of diffractive optical element components 10 via the light scanner collimating optical system 41.

Next, the laser driver 2 controls the laser light source 1 so that the laser light source 1 emits the laser light on the basis of the command from the control unit 8. The laser light source 1 emits the laser light on the basis of a command from the laser driver 2.

Next, the light scanner condensing optical system 40 condenses the laser light emitted from the laser light source 1 on the light scanner 4. Next, the light scanner 4 deflects the laser light in the first deflection direction so that the laser light emitted from the light scanner condensing optical system 40 is incident on the first diffractive optical element component out of the plurality of diffractive optical element components 10 via the light scanner collimating optical system 41.

Next, the light scanner collimating optical system 41 converts the laser light deflected by the light scanner 4 into parallel light incident on the first diffractive optical element component out of the plurality of diffractive optical element components 10.

Next, the first diffractive optical element component out of the plurality of diffractive optical element components 10 modulates at least one of the phase distribution or the intensity distribution of the laser light emitted from the light scanner collimating optical system 41 so that the laser light that passes therethrough forms a first light pattern on the image plane 9.

Next, the re-condensing optical system 32 condenses the laser light that passes through the first diffractive optical element component out of the plurality of diffractive optical element components 10 on the image plane 9. Next, the laser light emitted from the re-condensing optical system 32 forms the first light pattern on the image plane 9.

Next, the laser driver 2 controls the laser light source 1 so that the laser light source 1 stops the emission of the laser light on the basis of the command from the control unit 8. The laser light source 1 stops the emission of the laser light on the basis of the command from the laser driver 2.

Next, the light scanner driver 6 controls the light scanner 4 so that the light scanner 4 changes the deflection direction in which the laser light emitted from the light scanner condensing optical system 40 is deflected to a second deflection direction on the basis of a command from the control unit 8. The light scanner 4 changes the deflection direction in which the laser light emitted from the light scanner condensing optical system 40 is deflected to the second deflection direction on the basis of a command from the light scanner driver 6. Note that the laser light deflected in the second deflection direction by the light scanner 4 is incident on the second diffractive optical element component out of the plurality of diffractive optical element components 10 via the light scanner collimating optical system 41.

Next, the laser driver 2 controls the laser light source 1 so that the laser light source 1 emits the laser light on the basis of the command from the control unit 8. The laser light source 1 emits the laser light on the basis of a command from the laser driver 2.

Next, the light scanner condensing optical system 40 condenses the laser light emitted from the laser light source 1 on the light scanner 4. Next, the light scanner 4 deflects the laser light in the second deflection direction so that the laser light emitted from the light scanner condensing optical system 40 is incident on the first diffractive optical element component out of the plurality of diffractive optical element components 10 via the light scanner collimating optical system 41.

Next, the light scanner collimating optical system 41 converts the laser light deflected by the light scanner 4 into parallel light incident on the second diffractive optical element component out of the plurality of diffractive optical element components 10. Note that the incident angle of the parallel light incident on the first diffractive optical element component described above and the incident angle of the parallel light incident on the second diffractive optical element component coincide with each other.

Next, the second diffractive optical element component out of the plurality of diffractive optical element components 10 modulates at least one of the phase distribution or the intensity distribution of the laser light emitted from the light scanner collimating optical system 41 so that the laser light that passes therethrough forms a second light pattern on the image plane 9.

Next, the re-condensing optical system 32 condenses the laser light that passes through the second diffractive optical element component out of the plurality of diffractive optical element components 10 on the image plane 9. Next, the laser light emitted from the re-condensing optical system 32 forms the second light pattern on the image plane 9. Note that the position of the above-described first light pattern formed on the image plane 9 coincides with the position of the second light pattern formed on the image plane 9.

In the light pattern generation device 103, by repeating the above-described operation, the diffractive optical element component through which the laser light emitted from the light scanner collimating optical system 41 passes is continuously switched among the plurality of diffractive optical element components 10, so that animation is displayed on the image plane 9.

As described above, in the light pattern generation device 103 according to the fourth embodiment, the light scanner condensing optical system 40 that condenses the laser light emitted from the laser light source 1 on the light scanner 4 is mounted between the laser light source 1 and the light scanner 4, the light scanner collimating optical system 41 that converts the laser light deflected by the light scanner 4 into the parallel light the incident angle of which with respect to a predetermined diffractive optical element component out of the plurality of diffractive optical element components 10 is constant independently of the deflection direction of the light scanner 4 is mounted between the light scanner 4 and the diffractive optical element unit 7, and the re-condensing optical system 32 that condenses the laser light that passes through a predetermined diffractive optical element component out of the plurality of diffractive optical element components 10 in the same position on the image plane 9 is mounted between the diffractive optical element unit 7 and the image plane 9.

According to the above-described configuration, the laser light that passes through the re-condensing optical system 32 forms the light pattern in the same position on the image plane 9. As a result, it is possible to display animation in the same position on the image plane 9 by continuously switching the diffractive optical element component through which the laser light passes among the plurality of diffractive optical element components 10.

According to the above-described configuration, even in a case where the effective opening of the light scanner 4 is relatively small, the laser light can be incident on the light scanner 4 by the light scanner condensing optical system 40, and vignetting can be suppressed.

The light pattern generation device 103 according to the fourth embodiment is further provided with the light scanner driver 6 that controls the deflection direction of the light scanner 4 and the timing at which the deflection direction of the light scanner 4 is changed so that the light scanner 4 deflects the laser light emitted from the light scanner condensing optical system 40 toward a predetermined diffractive optical element component out of the plurality of diffractive optical element components 10 at a predetermined timing, in which the light scanner driver 6 controls the deflection direction of the light scanner 4 and the timing at which the deflection direction of the light scanner 4 is changed so that animation is displayed in the same position on the image plane 9 by continuously switching the diffractive optical element component through which the laser light emitted from the light scanner collimating optical system 41 passes among the plurality of diffractive optical element components 10.

According to the above-described configuration, when the light scanner driver 6 controls the light scanner 4, the diffractive optical element component through which the laser light emitted from the light scanner collimating optical system 41 passes is continuously switched among the plurality of diffractive optical element components 10. As a result, animation can be displayed in the same position on the image plane 9.

### Fifth Embodiment

In the third embodiment and the fourth embodiment, the configuration in which the re-condensing optical system 32 is mounted between the diffractive optical element unit 7 and the image plane 9 is described. In a fifth embodiment, a configuration in which a variable focus optical system is mounted between the diffractive optical element unit 7 and the image plane 9 is described.

Hereinafter, the fifth embodiment is described with reference to the drawings. Note that a component having a function similar to that in the component described in the first embodiment or the third embodiment is assigned with the same reference sign, and description thereof is not repeated.

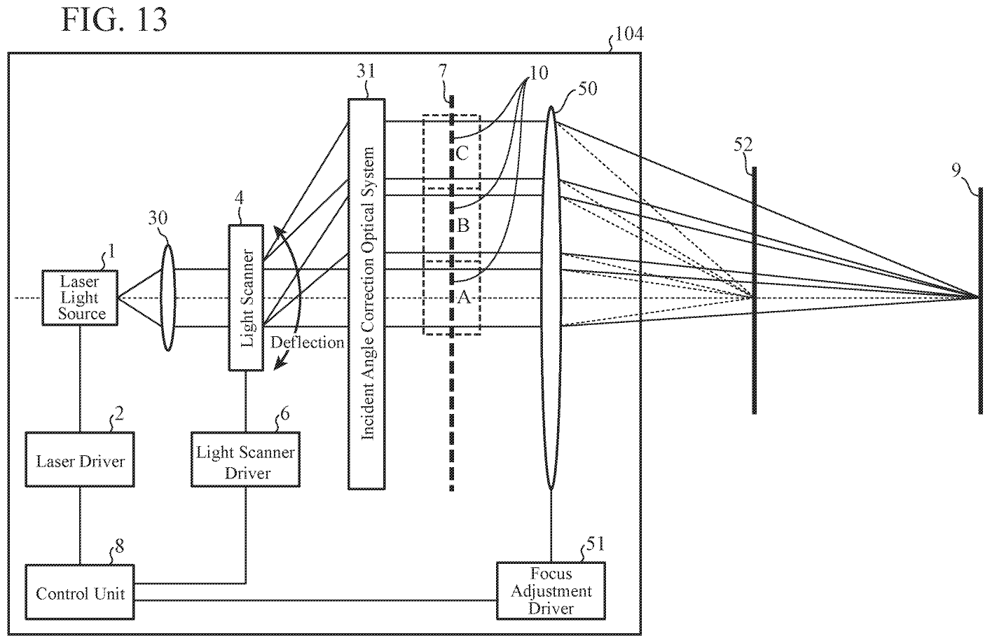

FIG. 13 is a diagram illustrating a configuration of a light pattern generation device 104 according to the fifth embodiment. As compared with the configuration of the light pattern generation device 102 according to the third embodiment, the light pattern generation device 104 is provided with a variable focus optical system 50 in place of the re-condensing optical system 32. The light pattern generation device 104 is further provided with a focus adjustment driver 51.

The variable focus optical system 50 is mounted between the diffractive optical element unit 7 and the image plane 9. A focal length of the variable focus optical system 50 can be changed so that laser light that passes through a predetermined diffractive optical element component out of the plurality of diffractive optical element components 10 is focused in the same position on any predetermined image plane. The variable focus optical system 50 is, for example, a plurality of lenses, liquid lenses or the like having a zoom function,

The focus adjustment driver 51 is connected to a control unit 8 and the variable focus optical system 50. The focus adjustment driver 51 controls the focal length of the variable focus optical system 50 so as to condense the laser light that passes through a predetermined diffractive optical element component out of the plurality of diffractive optical element components 10 in the same position on the image plane. In the fifth embodiment, the focus adjustment driver 51 controls the focal length of the variable focus optical system 50 so as to condense the laser light that passes through a predetermined diffractive optical element component out of the plurality of diffractive optical element components 10 in the same position on the image plane on the basis of a command from the control unit 8. Note that the focal length of the variable focus optical system 50 may be manually changed. In that case, the light pattern generation device 104 need not include the focus adjustment driver 51. As a result, the number of parts can be reduced, so that cost reduction and downsizing can be achieved.

Next, an operation of the light pattern generation device 104 according to the fifth embodiment is described. Note that the control unit 8 controls each of a laser driver 2, a light scanner driver 6, and the focus adjustment driver 51 on the basis of information stored in an internal memory not illustrated or externally input information.

First, the focus adjustment driver 51 controls the focal length of the variable focus optical system 50 so as to condense the laser light that passes through a predetermined diffractive optical element component out of the plurality of diffractive optical element components 10 in the same position on an image plane 52.

Next, the light scanner driver 6 controls the light scanner 4 so that a light scanner 4 changes a deflection direction in which the laser light emitted from a collimating optical system 30 is deflected to a first deflection direction on the basis of the command from the control unit 8. The light scanner 4 changes the deflection direction in which the laser light emitted from the collimating optical system 30 is deflected to the first deflection direction on the basis of a command from the light scanner driver 6. Note that the laser light deflected in the first deflection direction by the light scanner 4 is incident on the first diffractive optical element component out of the plurality of diffractive optical element components 10 via the incident angle correction optical system 31.

Next, the laser driver 2 controls the laser light source 1 so that the laser light source 1 emits the laser light on the basis of the command from the control unit 8. The laser light source 1 emits the laser light on the basis of a command from the laser driver

The collimating optical system 30 converts the laser light emitted from the laser light source into parallel light. Next, the light scanner 4 deflects the laser light in the first deflection direction so that the laser light emitted from the collimating optical system 30 is incident on the first diffractive optical element component out of the plurality of diffractive optical element components 10 via the incident angle correction optical system 31.

Next, the incident angle correction optical system 31 converts the laser light deflected by the light scanner 4 into parallel light incident on the first diffractive optical element component out of the plurality of diffractive optical element components 10.

Next, the first diffractive optical element component out of the plurality of diffractive optical element components 10 modulates at least one of phase distribution or intensity distribution of the laser light emitted from the incident angle correction optical system 31 so that the laser light that passes therethrough forms a first light pattern on the image plane 52.

Next, the variable focus optical system 50 condenses the laser light that passes through the first diffractive optical element component out of the plurality of diffractive optical element components 10 on the image plane 52. Next, the laser light emitted from the variable focus optical system 50 forms the first light pattern on the image plane 52.

Next, the laser driver 2 controls the laser light source 1 so that the laser light source 1 stops the emission of the laser light on the basis of the command from the control unit 8. The laser light source 1 stops the emission of the laser light on the basis of the command from the laser driver 2.

Next, the light scanner driver 6 controls the light scanner 4 so that the light scanner 4 changes the deflection direction in which the laser light emitted from the collimating optical system 30 is deflected to a second deflection direction on the basis of a command from the control unit 8. The light scanner 4 changes the deflection direction in which the laser light emitted from the collimating optical system 30 is deflected to the second deflection direction on the basis of the command from the light scanner driver 6. Note that the laser light deflected in the second deflection direction by the light scanner 4 is incident on the second diffractive optical element component out of the plurality of diffractive optical element components 10 via the incident angle correction optical system 31.

Next, the laser driver 2 controls the laser light source 1 so that the laser light source 1 emits the laser light on the basis of the command from the control unit 8. The laser light source 1 emits the laser light on the basis of a command from the laser driver 2.

Next, the collimating optical system 30 converts the laser light emitted from the laser light source 1 into parallel light. Next, the light scanner 4 deflects the laser light in the second deflection direction so that the laser light emitted from the collimating optical system 30 is incident on a first diffractive optical element component out of the plurality of diffractive optical element components 10 via the incident angle correction optical system 31.

Next, the incident angle correction optical system 31 converts the laser light deflected by the light scanner 4 into parallel light incident on a second diffractive optical element component out of the plurality of diffractive optical element components 10. Note that the incident angle of the parallel light incident on the first diffractive optical element component described above and the incident angle of the parallel light incident on the second diffractive optical element component coincide with each other.

Next, the second diffractive optical element component out of the plurality of diffractive optical element components 10 modulates at least one of the phase distribution or the intensity distribution of the laser light emitted from the incident angle correction optical system 31 so that the laser light that passes therethrough forms the second light pattern on the image plane 52.

Next, the variable focus optical system 50 condenses the laser light that passes through the second diffractive optical element component out of the plurality of diffractive optical element components 10 on the image plane 52. Next, the laser light emitted from the variable focus optical system 50 forms the second light pattern on the image plane 52. Note that a position of the above-described first light pattern formed on the image plane 52 coincides with a position of the second light pattern formed on the image plane 52.

In the light pattern generation device 104, by repeating the above-described operation, the diffractive optical element component through which the laser light emitted from the incident angle correction optical system 31 passes is continuously switched among the plurality of diffractive optical element components 10, so that animation is displayed on the image plane 52.

Note that, in a case where a positional relationship between the light pattern generation device 104 and the image plane 52 is changed, the control unit 8 adjusts the focal length of the variable focus optical system 50 via the focus adjustment driver 51 by changing the information stored in the internal memory described above or the externally input information.

As described above, in the light pattern generation device 104 according to the fifth embodiment, the incident angle correction optical system 31 that makes the incident angle of the laser light deflected by the light scanner 4 with respect to a predetermined diffractive optical element component out of the plurality of diffractive optical element components 10 constant independently of the deflection direction of the light scanner 4 is mounted between the light scanner 4 and the diffractive optical element unit 7, and the variable focus optical system 50 capable of changing the focal length so as to condense the laser light that passes through a predetermined diffractive optical element component out of the plurality of diffractive optical element components 10 in the same position on a predetermined image plane is mounted between the diffractive optical element unit 7 and the image plane 9.

According to the above-described configuration, the light pattern can be displayed in the same position on a predetermined image plane by changing the focal length of the variable focus optical system 50.

A distance between the light pattern generation device 104 and the image plane might vary depending on a situation in which the light pattern generation device 104 is placed or an application of the light pattern generation device 104. However, according to the above-described configuration, the light pattern can be displayed on the image plane after the variation by changing the focal length of the variable focus optical system 50. That is, the light pattern generation device 104 can cope with various situations or various applications.

In the light pattern generation device 104 according to the fifth embodiment, the variable focus optical system 50 is further provided with the focus adjustment driver 51 that controls the focal length of the variable focus optical system 50 so as to condense the laser light that passes through a predetermined diffractive optical element component out of the plurality of diffractive optical element components 10 in the same position on a predetermined image plane.

According to the above-described configuration, the focal length of the variable focus optical system 50 can be suitably changed, and the light pattern can be displayed in the same position on a predetermined image plane.

Note that, although an example in which the variable focus optical system 50 and the focus adjustment driver 51 are applied to the light pattern generation device 102 according to the third embodiment is described in the fifth embodiment, the variable focus optical system 50 and the focus adjustment driver 51 may also be applied to the light pattern generation device 103 according to the fourth embodiment.

In this case, in the light pattern generation device, the light scanner condensing optical system 40 that condenses the laser light emitted from the laser light source 1 on the light scanner 4 is mounted between the laser light source 1 and the light scanner 4, the light scanner collimating optical system 41 that converts the laser light deflected by the light scanner 4 into the parallel light the incident angle of which with respect to a predetermined diffractive optical element component is constant independently of the deflection direction of the light scanner 4 is mourned between the light scanner 4 and the diffractive optical element unit 7, and the variable focus optical system 50 capable of changing the focal length so as to condense the laser light that passes through a predetermined diffractive optical element component out of the plurality of diffractive optical element components 10 in the same position on a predetermined image plane is mounted between the diffractive optical element unit 7 and the image plane 9.

In this case, in the light pattern generation device, the variable focus optical system 50 is further provided with the focus adjustment driver 51 that controls the focal length of the variable focus optical system 50 so as to condense the laser light that passes through a predetermined diffractive optical element component out of the plurality of diffractive optical element components 10 in the same position on a predetermined image plane.

According to each configuration described above, an effect similar to each effect achieved by the light pattern generation device 104 according to the fifth embodiment is achieved.

Note that, in the invention of the present application, the embodiments can be freely combined, any component of each embodiment can be modified, or any component can be omitted in each embodiment without departing from the scope of the invention.

### INDUSTRIAL APPLICABILITY

Since the light pattern generation device according to the present invention can improve flexibility of the order of the displayed light patterns, this can be used for a technology of displaying the light pattern.

### REFERENCE SIGNS LIST

1: laser light source, 2: laser driver, 3: condensing optical system, 4: light scanner, 6: light scanner driver, 7: diffractive optical element unit, 8: control unit, 9: image plane, 10: plurality of diffractive optical element components, 20: diffractive optical element unit, 21: plurality of diffractive optical element components, 22: two-dimensional scan element, 23: one-dimensional scan element, 24: addressing optical system, 30: collimating optical system, 31: incident angle correction optical system, 32: re-condensing optical system, 33: telecentric optical system, 34: collimating optical system. 35: prism array, 40: light scanner condensing optical system, 41: light scanner collimating optical system, 50: variable focus optical system, 51: focus adjustment driver, 52: image plane, 100, 101, 102, 103, 104: light pattern generation device

1. A light pattern generation device comprising:
a laser light source to emit laser light;
a light scanner to deflect the laser light emitted from the laser light source;
a diffractive optical element unit including a plurality of diffractive optical element components each of which modulates at least one of phase distribution or intensity distribution of the laser light deflected by the light scanner so that the laser light that passes through each of the diffractive optical element components forms a predetermined light pattern on an image plane; and
a light scanner driver to control a deflection direction of the light scanner in which the laser light emitted from the laser light source is deflected and a timing at which the deflection direction of the light scanner is changed so that the light scanner deflects the laser light emitted from the laser light source toward a predetermined diffractive optical element component out of the plurality of diffractive optical element components at a predetermined timing, wherein
the light scanner is capable of changing the deflection direction so that the laser light emitted from the laser light source is deflected toward a predetermined diffractive optical element component out of the plurality of diffractive optical element components, and
the light scanner driver controls the deflection direction of the light scanner and the timing at which the deflection direction of the light scanner is changed in such a manner that the light pattern displayed on the image plane is switched by continuously switching the diffractive optical element component through which the laser light deflected by the light scanner passes among the plurality of diffractive optical element components in a predetermined order so that animation is displayed in a same position on the image plane, and
a pitch of each of the plurality of diffractive optical element components, each of which includes a plurality of periodically divided minute portions, the pitch being a width of each of the minute portions, is set so that the laser light that passes through each of the diffractive optical element components forms a predetermined light pattern in the same position on the image plane.

2. The light pattern generation device according to claim 1 further comprising:
a controller to control the light scanner driver so as to control the deflection direction of the light scanner on a basis of a signal input from an internal memory or an externally input signal, wherein
the controller controls a command for the deflection direction of the light scanner to the light scanner driver in accordance with the signal input from the internal memory or the externally input signal so that a pattern of the animation displayed in the same position on the image plane is changed to a predetermined pattern.

3. A light pattern generation device comprising:
a laser light source to emit laser light;
a light scanner to deflect the laser light emitted from the laser light source;
a diffractive optical element unit including a plurality of diffractive optical element components each of which modulates at least one of phase distribution or intensity distribution of the laser light deflected by the light scanner so that the laser light that passes through each of the diffractive optical element components forms a predetermined light pattern on an image plane; and
a light scanner driver to control a deflection direction of the light scanner in which the laser light emitted from the laser light source is deflected and a timing at which the deflection direction of the light scanner is changed so that the light scanner deflects the laser light emitted from the laser light source toward a predetermined diffractive optical element component out of the plurality of diffractive optical element components at a predetermined timing, wherein
the light scanner is capable of changing the deflection direction so that the laser light emitted from the laser light source is deflected toward a predetermined diffractive optical element component out of the plurality of diffractive optical element components, and
the light scanner driver controls the deflection direction of the light scanner and the timing at which the deflection direction of the light scanner is changed in such a manner that the light pattern displayed on the image plane is switched by continuously switching the diffractive optical element component through which the laser light deflected by the light scanner passes among the plurality of diffractive optical element components in a predetermined order so that animation is displayed in a same position on the image plane, and
an incident angle correction optical system to convert the laser light deflected by the light scanner into parallel light whose incident angle with respect to the predetermined diffractive optical element component is constant independently of the deflection direction of the light scanner is mounted between the light scanner and the diffractive optical element unit, and
a re-condensing optical system to condense the parallel light emitted from the predetermined diffractive optical element component in the same position on the image plane independently of the diffractive optical element component through which the laser light passes is mounted between the diffractive optical element unit and the image plane.

4. The light pattern generation device according to claim 3, further comprising:
a controller to control the light scanner driver so as to control the deflection direction of the light scanner on a basis of a signal input from an internal memory or an externally input signal, wherein
the controller controls the light scanner driver so as to control the deflection direction of the light scanner in accordance with the signal input from the internal memory or the externally input signal so that a pattern of the animation displayed in the same position on the image plane is changed to a predetermined pattern.

5. The light pattern generation device according to claim 3, wherein
the incident angle correction optical system includes a telecentric optical system to make a principal light beam of the laser light deflected by the light scanner parallel to an optical axis, and a collimating optical system array to convert the laser light whose principal light beam is made parallel to the optical axis by the telecentric optical system into the parallel light.

6. The light pattern generation device according to claim 3, wherein
the incident angle correction optical system includes a prism array to convert the laser light deflected by the light scanner into the parallel light whose incident angle with respect to the predetermined diffractive optical element component is constant independently of the deflection direction of the light scanner.

7. The light pattern generation device according to claim 3, wherein
the re-condensing optical system is a variable focus optical system which is capable of changing its focal length so that the laser light that passes through the predetermined diffractive optical element component is condensed in the same position on a predetermined image plane.
